(19) United States
(12) Patent Application Publication
(10) Pub. No.: US 2020/0157748 A1
(43) Pub. Date: May 21, 2020

(54) Permeable Paving System

(71) Applicant: PaveDrain, LLC, Milwaukee, WI (US)

(72) Inventor: Douglas J. Buch, Greenfield, WI (US)

(21) Appl. No.: 16/671,276

(22) Filed: Nov. 1, 2019

Related U.S. Application Data
(62) Division of application No. 14/776,071, filed on Sep. 14, 2015.
(60) Provisional application No. 61/791,776, filed on Mar. 15, 2013.

(51) Int. Cl. E01C 11/22; E01C 11/26; E01C 5/06; E01C 13/00; E01C 13/04

(52) U.S. Cl. CPC E01C 11/225; E01C 11/265; E01C 5/06; E01C 13/00; Y02A 30/32; E01C 2201/167; E01C 2201/207; E01C 2201/06; E01C 13/04

(57) ABSTRACT

Systems and methods for a permeable pavement system are described. The permeable pavement system includes blocks designed to facilitate water seepage between the blocks and to permit water storage within the blocks. The blocks may be cabled together to create paving units that facilitate installation and maintenance of the pavement system. The permeable pavement system may also be heated to a predetermined range with either electrical energy or hydronic heating.

### CROSS-REFERENCE TO RELATED APPLICATIONS

This application claims priority to U.S. application Ser. No. 14/776,071, filed on Sep. 14, 2016, which claims priority to and is a nationalization of International Application No. PCT/US2014/027753, filed on Mar. 14, 2014, which claims priority to U.S. provisional patent application No. 61/791,776, filed on Mar. 15, 2013, the entire contents of each being incorporated herein by reference.

### BACKGROUND OF THE INVENTION

### 1. Field of the Invention

The present invention relates in general to the field of paving systems. More particularly, the present invention relates to a modular, permeable paving system. Specifically, a preferred embodiment of the present invention relates to a permeable paving system utilizing paving units made from blocks cabled together and providing fluid storage within the blocks.

### 2. Discussion of the Related Art

As is known to those skilled in the art, paving systems historically create a surface impervious to rain. The water that falls on the paved surface runs off the edge of the paving surface rather than being absorbed into the ground beneath the paved surface. It is recognized that an increasing number of paved surfaces and the subsequent stormwater runoff from these paved surfaces contribute to lowered water tables and rising stream levels. Thus, it is a previously recognized problem with paving systems that stormwater runoff needs to be managed.

Historically, it was known in the prior art to manage stormwater using a curb and gutter system to guide the stormwater into sewer systems. More recently the stormwater has been guided into detention basins to allow the water to be absorbed closer to the paved surface. Needless to say, it is desirable to provide a permeable pavement system allowing the stormwater to drain through the paving system and to be absorbed into the ground under the paving system, minimizing the need for any additional stormwater management system.

However, such a permeable pavement system has not been fully realized without incurring various disadvantages. For example, U.S. Pat. Nos. 5,797,698 and 6,939,077 disclose paving elements designed to allow water to drain between adjacent paving blocks. While these paver blocks, as disclosed, allow stormwater to drain down the sides of the block, they are still susceptible to one of the major drawbacks of existing permeable pavement systems: they are dependent on the aggregate interlock and aggregate subgrade and the underlying soil for infiltration. Sandy or rocky soils have more cracks and fissures that allow the water to filter into and away from the surface, but heavy, clay soils do not drain quickly and require a longer retention time prior to the water entering the soil.

Another previously recognized approach to solving the problem of being dependent on the subgrade and soil for infiltration involves the use of underground storage systems. These storage systems are made of plastic and have several feet of aggregate dumped on top of them. A disadvantage of this approach is the inability to clean out the underground storage systems once they are filled with sedimentation and particulates from stormwater runoff Therefore, a preferred solution will manage the stormwater runoff to improve infiltration of the water into any type of soil and, if it becomes necessary, will allow for sedimentation to be cleaned out from the water storage system.

### SUMMARY AND OBJECTS OF THE INVENTION

Consistent with the foregoing and in accordance with the invention as embodied and broadly described herein, a paver block and a permeable pavement system are disclosed in suitable detail to enable one of ordinary skill in the art to make and use the invention.

A permeable paving system may include a plurality of blocks with each block having an upper surface, a lower surface generally parallel to and spaced apart from the upper surface, a first side, a second side—opposite the first side, a pair of parallel ducts extending horizontally through the block between the upper surface and the lower surface, and a transmission device extending through at least one duct in each one of the plurality of blocks forming a circuit.

A controlling device may be included that selectively adjusts one of electrical current or a circulation of a fluid flowing through the transmission device such that the temperature of the plurality of blocks is automatically maintained at a predetermined range. The predetermined temperature range of the plurality of blocks is preferably 35 to 39 degrees Fahrenheit.

When using liquid, a pump may be used to circulate the fluid. The transmission device may further include at least one tube inserted through and defining a circuit through the at least one duct in each one of the blocks of the plurality of blocks allowing the fluid to flow through the tube. Furthermore, when using liquid, a heat exchanger may be connected in series with the tube to exchange thermal energy between the fluid and the heat exchanger.

Preferably, the transmission device is an electrically conductive wire encapsulated within a non-electrically conducting sheath. The transmission device may also be a cable capable of supporting the weight of the plurality of blocks and joining each one of the plurality of blocks together thus forming a mattress. The temperature controlled blocks may be regulated such that ice is prevented from forming or accumulating on the plurality of blocks.

The controlling device may include a thermostat programmed to control the amperage of the electrical current flowing through the transmission device, or control the pump flowing liquid in order to maintain the predetermined temperature. When controlling electricity, the amperage may by controlled to maintain the predetermined temperature range of the plurality of blocks.

Also, when using electricity, an electricity storage device capable of storing a solar energy and configured to transmit the stored solar energy to the transmission device may be used. The controlling device may also be a thermostat programmed to deliver the stored solar energy as the electrical current and control an amperage of the electrical current flowing through the transmission device to maintain the predetermined temperature range of the plurality of blocks within.

Each block may be defined as having an upper surface, a lower surface generally parallel to and spaced apart from the upper surface, a first, second, third, and fourth side, each side having a height and connecting the upper and the lower surface. A first side may be non-planar and a second side, opposite the first side, may also be non-planar and complementary to the first side such that the first side of the block engages the second side of a second block placed adjacent to the block to restrict lateral movement of the adjacent blocks.

Each plurality of blocks may also include a generally rounded upper edge at the connection of each side to the upper surface. A pair of ducts extending through the block between the first side and the second side, wherein at least a portion of each of the first side and the second side slopes toward the rounded upper edge may also be included in each block. Each block may also include at least one spacer protruding from at least one of the plurality of sides and extending along at least a portion of the height of the side. Each spacer may be configured to engage one of the sides of an adjacent block, defining a gap therebetween. Each of the first and second sides may include a first, central surface, a second surface stepped toward an outer periphery of the block from the first surface, a third surface stepped an equal distance toward the outer periphery along an opposite edge of the first surface, a fourth surface stepped to the outer periphery from the second surface, and a fifth surface stepped to the outer periphery from the third surface.

Each plurality of blocks may also include one of a continuous cables and a continuous wire joining the blocks. Each block may have an upper surface, a lower surface including a cavity, wherein the cavity is an arched channel extending along a length of the block. Each block may also have a pair of ducts extending through the block between the first side and the second side, wherein at least a portion of each of the first side and the second includes a side slope angled toward the upper surface.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a top view of one embodiment of a block incorporated into the paving system according to the present invention;

FIG. 2 is a sectional view taken along 2-2 of FIG. 1;

FIG. 3 is an end view of the embodiment of the block of FIG. 1;

FIG. 4 is a side view of the embodiment of the block of FIG. 1;

FIG. 5 is an end view of another embodiment of a block incorporated into the paving system according to the present invention;

FIG. 6 is a top view of another embodiment of a block incorporated into the paving system according to the present invention;

FIG. 7 is a sectional view taken along 7-7 of FIG. 6;

FIG. 8 is an end view of the embodiment of the block of FIG. 6;

FIG. 9 is a right side view of the embodiment of the block of FIG. 6;

FIG. 10 is a left side view of the embodiment of the block of FIG. 6;

FIG. 11 is a top view of one embodiment of a paving unit incorporated into the paving system according to the present invention;

FIG. 12 is a sectional view taken along 12-12 of FIG. 11;

FIG. 13 is a top view of one embodiment of the present invention;

FIG. 14 is a bottom view of a joint connecting two paving units according to the embodiment shown in FIG. 13;

FIG. 15 is a sectional view taken along 15-15 of FIG. 14;

FIG. 16 is a partial bottom view of another embodiment of a paving unit incorporated into the paving system according to the present invention;

FIG. 17 is a sectional view of a paving unit as shown in FIG. 16 being positioned end-to-end to another paving unit as shown in FIG. 16;

FIG. 18 is a partial bottom view of the two paving units shown in FIG. 17 without a lock block inserted;

FIG. 19 is a partial sectional view of the two paving units shown in FIG. 17 without a lock block inserted;

FIG. 20 is a partial bottom view of the two paving units shown in FIG. 17 with a lock block inserted;

FIG. 21 is a partial sectional view of the two paving units shown in FIG. 17 with a lock block inserted;

FIG. 22 is an exemplary embodiment of lifting a paving unit;

FIG. 23 shows a perspective view of another embodiment of the present invention;

FIG. 24 is a top view of another embodiment of a block incorporated into the paving system according to the present invention;

FIG. 25 is a sectional view taken along 25-25 of FIG. 24;

FIG. 26 is an end view of the embodiment of the block of FIG. 24;

FIG. 27 is a right side view of the embodiment of the block of FIG. 24;

FIG. 28 is a left side view of the embodiment of the block of FIG. 24;

FIG. 29 is a top view of another embodiment of a paving unit incorporated into the paving system according to the present invention;

FIG. 30 is a block diagram representation of a paving system according to one embodiment of the invention;

FIG. 31 is a perspective view of an end cap according to an additional embodiment of the present invention;

FIG. 32 is a top view of the end cap according to FIG. 31;

FIG. 33 is a bottom view of the end cap according to FIG. 31;

FIG. 34 is a perspective view of the end cap of FIG. 31 next to a paving block;

FIG. 35 is a top view of a paving block system including paving blocks and end caps according to an embodiment of the invention;

FIG. 36 is a side view of the paving block system of FIG. 34 installed in a typical environment according to the present invention;

FIG. 37 is a flow chart describing the steps to create a paving block system with an end cap according to an embodiment of the invention;

FIG. 38 is a flow chart describing the steps to install a paving block system and end cap according to an embodiment of the invention;

FIG. 39 is a top view of an end block showing an alternative embodiment of the invention;

FIG. 40 is a side view of the end block according to FIG. 39;

FIG. 41 is a front view of the end block according to FIG. 39;

FIG. 42 is a back view of the end block according to FIG. 39; and

FIG. 43 is a top view of a paving block system including paving blocks and end blocks according to another embodiment of the invention.

In describing the preferred embodiments of the invention which are illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “connected”, “attached”, or terms similar thereto are often used. They are not limited to direct connection but include connection through other elements where such connection is recognized as being equivalent by those skilled in the art.

### DESCRIPTION OF PREFERRED EMBODIMENTS

This application hereby incorporates the entire contents by reference of U.S. Pat. No. 8,459,896, issued Jun. 11, 2013, U.S. Pat. No. 8,251,607, issued Aug. 28, 2012, and international application no. PCT/US13/77770, filed on Dec. 26, 2013.

Specific embodiments of the present invention will now be further described by the following, non-limiting examples which will serve to illustrate various features of significance. The examples are intended merely to facilitate an understanding of ways in which the present invention may be practiced and to further enable those of skill in the art to practice the present invention. Accordingly, the examples should not be construed as limiting the scope of the present invention.

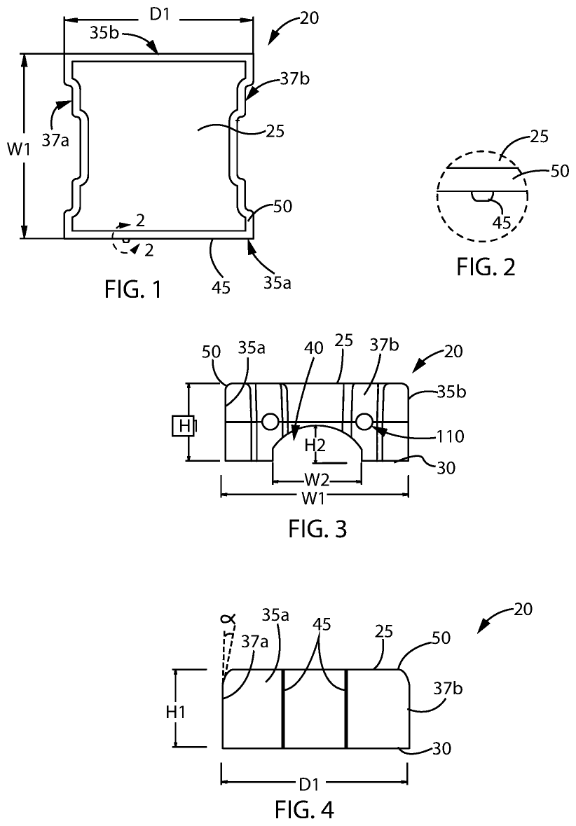

Turning initially to FIGS. 1-4, one embodiment of a block 20 used in a permeable pavement or permeable paving system 100 is illustrated. The block 20 is generally comprised of an upper surface 25, a lower surface 30, a first side wall, or side, 35a, a second side wall, or side, 35b, a first end 37a, a second end 37b, and a cavity 40. It is contemplated that the block 20, for example, a paver block, could be of any shape known to one of ordinary skill in the art, including, but not limited to, a square, a rectangle, and a hexagon. As illustrated in FIG. 1, the paver block 20 has two generally flat sides, 35a and 35b, and two stepped ends, 37a and 37b. Additionally, the paver block 20, may be manufactured in a variety of heights, H1, widths, W1, and depths, D1. Preferably, the range of dimensions for the paver block 20 is from 9 to 15 inches (22.9 to 38.1 cm) wide, 9 to 15 inches (22.9 to 38.1 cm) deep, and 4 to 7 inches (10.2 to 17.8 cm) high. In one embodiment, the block is about 12 inches (30.5 cm) wide, 12 inches (30.5 cm) deep and 5 inches (12.7 cm) high. The paver block may be manufactured out of any material known to one of ordinary skill in the art, but is preferably a concrete block. At least one drainage spacer 45 extends at least partially along one of the sides, 35a or 35b, of the paver block 20. As illustrated in FIGS. 1 and 4, two drainage spacers 45 may extend vertically along the entire height, H1, of one of the sides, 35a or 35b, of the paver block 20. In addition, at least one, and preferably all, of edges 50 between the upper surface 25 and each of the sides, 35a and 35b, and each of the ends, 37a and 37b, will be rounded, creating seepage down the block.

When used in a permeable pavement or permeable paving system 100, multiple paver blocks 20 may be installed as a single paving unit 115 to increase the speed and efficiency of installation. To permit installation as a single paving unit 115, each paver block 20 includes holes or ducts 110 passing through the paver block 20. Each duct 110 is sized to allow a cable 105 to pass therethrough, and is preferably about one inch in diameter. In addition, the ends, 37a and 37b, of the blocks through which the ducts 110 pass will have some angle, alpha (α), between the end, 37a or 37b, and a vertical plane. It is desirable to minimize this angle as much as possible; however, the angle provides flexibility between blocks in a paving unit 115. It is desirable to keep this angle, alpha (α), at about 3 degrees and preferably between 1 and 5 degrees. See, for example, FIG. 4.

Referring next to FIGS. 6-10, another embodiment of a paver block 20 used in the permeable paving system 100 is illustrated. The paver block 20 is generally comprised of an upper surface 25, a lower surface 30, a first side 35a, a second side 35b, a first end 37a, a second end 37b, and a cavity 40. The paver block 20 has two flat sides, 35a and 35b, and two stepped ends, 37a and 37b. It is contemplated that each of the ends, 37a and 37b, may have various non-planar, geometric configurations other than the stepped end such that when placed next to each other, the first end 37a and the second end 37b restrict lateral movement between adjacent blocks. The paver block 20, may be manufactured in a variety of heights, H1, widths, W1, and depths, D1. The illustrated embodiment of the paver block 20 is about 11.8 inches (30 cm) wide, 11.8 inches (30 cm) deep and 5.6 inches (14.2 cm) high. A pair of drainage spacers 45 protrudes from and extends at least partially along each of the flat sides, 35a or 35b, of the paver block 20. Further, the drainage spacers 45 on a first flat side 35a are laterally aligned such that they are offset from the drainage spacers 45 on a second flat side 35b. Thus, when two paver blocks 20 are placed adjacent to each other, the drainage spacers 45 on the first flat side 35a of the first paver block 20 engage the second flat side 35b of the second paver block 20. Similarly, the drainage spacers 45 on the second flat side 35a of the second paver block 20 engage the first flat side 35b of the first paver block 20. The drainage spacers 45 may be manufactured in a variety of heights, H4, widths, W4, and depths, D4. Preferably, the range of dimensions for the drainage spacers 45 is from ⅛ to 2 inches (0.3 to 5.1 cm) wide, 1/16 to ½ inches (0.2 to 1.3 cm) deep, and from one-half the height, H1, of the paver block 20 to the entire height, H1 of the paver block. The drainage spacers 45 of the illustrated embodiment are about 1 inch (2.5 cm) wide, ⅜ inches (1.0 cm) deep, and about 80 percent of the height, H1, of the paver block 20.

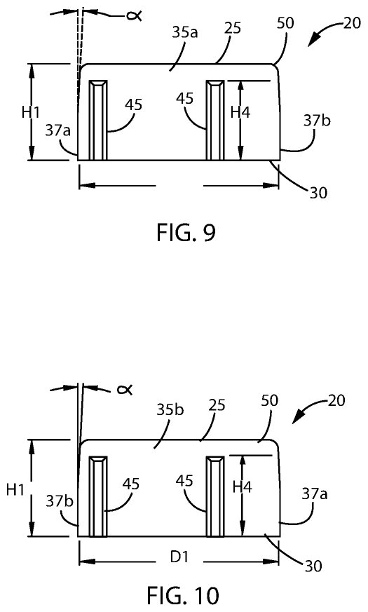

Each paver block 20 also includes ducts 110 passing from the first end 37a to the second end 37b of the paver block 20. Each duct 110 is sized to allow a cable 105 to pass therethrough and may have any suitable cross-section. As illustrated in FIG. 8, an upper portion 112 of the duct 110 may be curved and a lower surface 114 of the duct 110 may be planar. Referring to FIGS. 9 and 10, the ends, 37a and 37b, of the blocks through which the ducts 110 pass will have some angle, alpha (α), between the end, 37a or 37b, and a vertical plane. It is desirable to minimize this angle as much as possible; however, the angle provides flexibility between blocks in a paving unit 115. It is desirable to keep this angle, alpha (α), at about 3 degrees and preferably between 1 and 5 degrees.

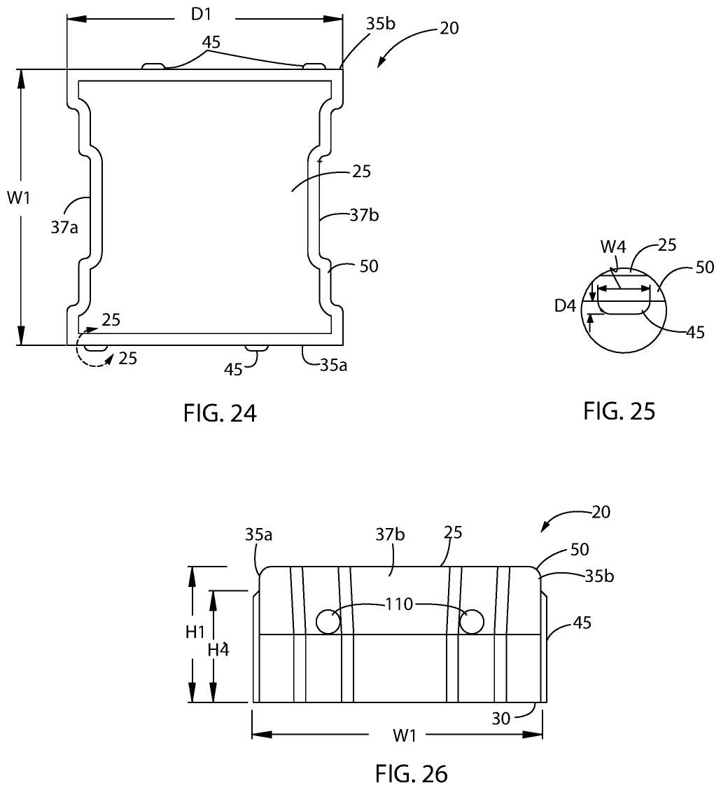

Referring next to FIGS. 24-28, another embodiment of a paver block 20 used in the permeable paving system 100 is illustrated. The paver block 20 is generally comprised of an upper surface 25, a lower surface 30, a first side 35a, a second side 35b, a first end 37a, and a second end 37b. The paver block 20 has two substantially flat sides, 35a and 35b, and two stepped ends, 37a and 37b. It is contemplated that each of the ends, 37a and 37b, may have various non-planar, geometric configurations other than the stepped end such that when placed next to each other, the first end 37a and the second end 37b restrict lateral movement between adjacent blocks. The paver block 20, may be manufactured in a variety of heights, H1, widths, W1, and depths, D1. The illustrated embodiment of the paver block 20 is about 11.8 inches (30 cm) wide, 11.8 inches (30 cm) deep and 5.6 inches (14.2 cm) high. A first drainage spacer 45 and a second drainage spacer 45 each protrudes from and extends, at least partially, along each of the flat sides, 35a or 35b, of the paver block 20. Further, the drainage spacers 45 on a first flat side 35a are aligned laterally along the wall such that they are offset from the drainage spacers 45 on a second flat side 35b. Thus, when two paver blocks 20 are placed adjacent to each other, the drainage spacers 45 on the first flat side 35a of the first paver block 20 engage the second flat side 35b of the second paver block 20. Similarly, the drainage spacers 45 on the second flat side 35a of the second paver block 20 engage the first flat side 35b of the first paver block 20. The drainage spacers 45 may be manufactured in a variety of heights, H4, widths, W4, and depths, D4. Preferably, the range of dimensions for the drainage spacers 45 is from ⅛ to 2 inches (0.3 to 5.1 cm) wide, 1/16 to ½ inches (0.2 to 1.3 cm) deep, and from one-half the height, H1, of the paver block 20 to the entire height, H1 of the paver block. The drainage spacers 45 of the illustrated embodiment are about 1 inch (2.5 cm) wide, ⅜ inches (1.0 cm) deep, and about 80 percent of the height, H1, of the paver block 20. In addition, at least one, and preferably all, of edges 50 between the upper surface 25 and each of the sides, 35a and 35b, and each of the ends, 37a and 37b, will be rounded, creating seepage down the block.

Each paver block 20 also includes ducts 110 passing from the first end 37a to the second end 37b of the paver block 20. Each duct 110 is sized to allow a cable 105 to pass therethrough and may have any suitable cross-section. As illustrated in FIG. 26, each duct 110 may by cylindrical and have a diameter of about 1 inch (25.4 cm). Optionally, each duct 110 may be sized to allow a transmission device which may include tubing 150 to pass therethrough. Each duct 110 may again be cylindrical but the diameter be of a suitable size to have tubing carrying liquid to either heat or cool the block. The diameter may be, for example, between one-half (½) inch (12.7 cm) and two (2) inches (50.8 cm) in diameter. The transmission device may also form a cutwork, or circuit, of tubing 150 or other transmission means for fluid or other thermal energy to be transmitted.

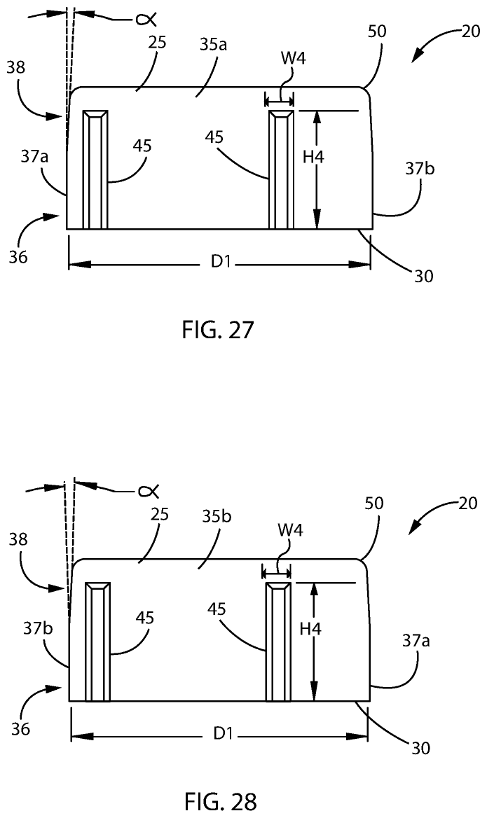

Referring to FIGS. 27 and 28, the ends, 37a and 37b, of the blocks through which the ducts 110 pass include a lower portion 36 and an upper portion 38. The lower portion 36 of each end, 37a and 37b, is generally orthogonal to the lower surface 30 of each paver block 20 and the upper portion 38 of each end, 37a and 37b, is sloped inward from the lower portion 36 toward the upper surface 25 of each paver block 20 such that an angle, alpha (α), exists between the upper portion 38 of each end, 37a or 37b, and a plane projected upward from the lower portion 36. It is desirable to minimize this angle as much as possible; however, the angle provides flexibility between blocks in a paving unit 115. It is desirable to keep this angle, alpha (α), at about 3 degrees and preferably between 1 and 5 degrees.

In one embodiment, the paver block's arch is reduced or completely removed. This more “solid” block may be used for several potential projects that have loading higher than what the “standard” block is rated for, e.g., shipping ports where they use huge mobile gantry cranes. Of course, other block features may also be altered to allow the paver block to function in this high load environment.

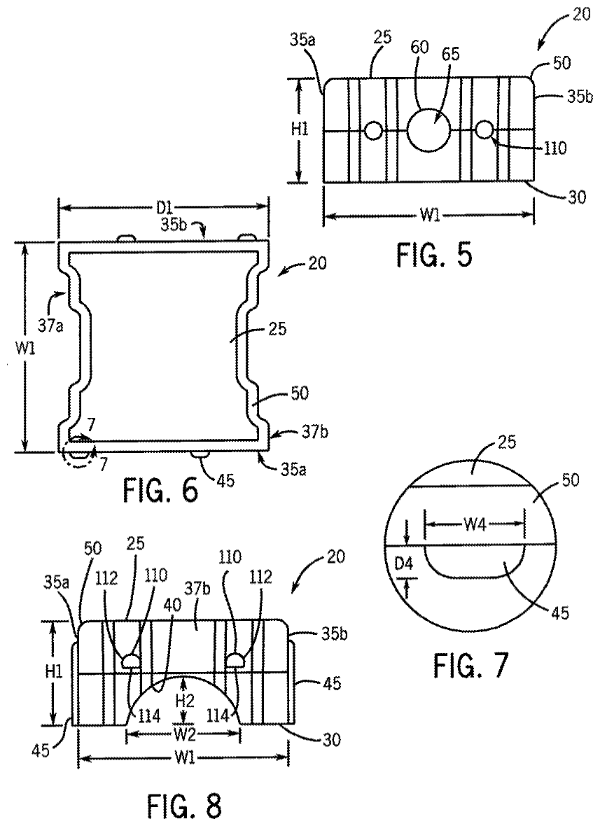

Referring next to FIGS. 3 and 8, a cavity 40 allows fluid storage within the paver block 20 and is configured to contain stormwater that has drained down the paver block 20. The cavity 40 may be partially or wholly defined by the paver block 20. The cavity 40 may be designed in a wide variety of shapes and sizes to allow for fluid storage within the paver block 20. In the illustrated embodiment, the cavity 40 is an arch extending along the entire depth, D1, of the lower surface 30. Another embodiment of the cavity 40 is shown in FIG. 5 wherein the cavity 40 is a fluid passage 65 extending entirely through the paver block 20. A further embodiment of the cavity 40, not illustrated, may include multiple fluid passages 65 extending through the paver block 20. Still another embodiment of the cavity 40, not illustrated, may be an arch extending along one or both of the sides, 35a and 35b, of the paver block. The afore-mentioned examples disclose several embodiments for the cavity 40, but the structure of the cavity 40 could be any shape or size capable of storing fluid within the block such as, but not limited to, a square, rectangular, or triangular cavity extending across the bottom, side, or through the paver block 20. The cavity 40 extends generally along the center line of the block 20 defining, at least in part, a first and second generally planar portion of the lower surface 114 extending along the cavity 40 and between each of the first side 35a and the second side 35b, respectively, of the block 20. Because the width of the cavity 40 may vary between about 25 to about 60 percent of the width of the lower surface 114, the first and second planar portions of the lower surface 114 may conversely define between about 40 and 75 percent of the lower surface 114. In one preferred embodiment, the cavity 40 is an arched channel having a radius of about 3.3 inches (8.5 cm) and a height of about 2.6 inches (6.5 cm) as shown in FIG. 8.

The paver block 20 is designed to balance fluid storage and structural integrity. Preferably, the volume of the cavity 40 allows for at least the first inch (2.5 cm) of stormwater that falls on the upper surface 25 of the paver block 20 to be stored within the cavity 40 of the paver block 20. This stored water subsequently filters out of the cavity 40 into the aggregate subgrade 135 and soil below the paving system 100.

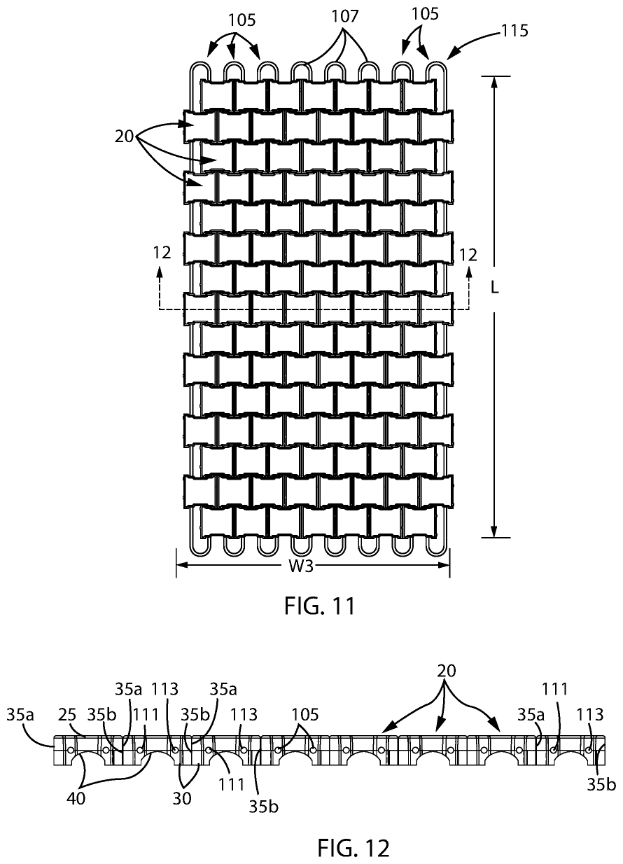

Referring next to FIGS. 11 and 12, a paving unit 115 is constructed by passing multiple cables 105 through multiple paver blocks 20. As illustrated, each paver block 20 may have a first duct 111 positioned proximate to the first side 35a and a second duct 113 proximate to the second side 35b. The cable 105 may be inserted alternately through a first duct 111 and a second duct 113 of successive blocks. Optionally, the cable 105 may be inserted exclusively through either the first duct 111 or the second duct 113 of each block 20. It is contemplated that the cable 105 may be, but is not limited to, one of the following materials: polyester, stainless steel, and galvanized steel. The resulting paving defines a first side 116, a second side 118, a first end 117, and a second end 119.

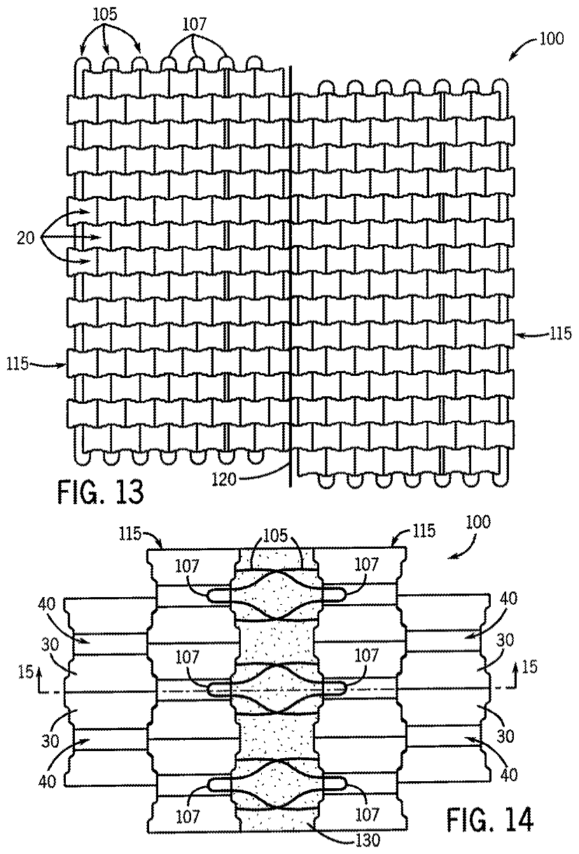

According to one embodiment of the invention, illustrated in FIGS. 11 and 13, the cable 105 may protrude a short distance beyond the end of the last block 20 and loop back through the blocks 20 to create a lifting loop 107 at the end of each paving unit 115. According to another embodiment of the invention, each cable 105 may terminate after passing through a single set of aligned ducts 110. A first lifting loop 107 may be formed by looping back one end of the cable 105 and securing it to itself by any suitable device, such as a ferrule, clamp, or clip. A second lifting loop 107 may similarly be formed by looping back the other end of the cable 105 and securing it to itself.

In another embodiment, two cables are preferably connected to provide a singular cable and lifting loop. The cables preferably extend a foot or two beyond the side of the block and are crimped together to form a singular loop with metal crimps. In order to maximize cable movement when placing the paving unit 115, there are no washers or spacers provided between the end of the cable loop and the block and the crimps are far enough away to minimize interference. Once the unit is set in place, the singular cable is used to tighten the individual blocks within unit up. The cable is then folded over under the cavity of the last blocks in the unit. The cable is preferably made of a polyester wrapped with nylon sheath for strength and integrity.

It is contemplated that the paving unit 115 will be of varying widths, W3, and lengths, L, to accommodate the desired application, including, but not limited to, pathways, driveways, parking lots, and roads. Preferably, the paving unit 115 is about 8 feet (2.4 m) wide and may extend from 8 to 60 feet (2.4 to 18.3 m) in length. Based on its application, the paver block 20 may accommodate either pedestrian or vehicular traffic. The paver block 20 is preferably designed to accommodate a load of up to 4000 pounds per square inch (19.2 newton per square centimeter).

Referring next to FIG. 13, multiple paving units may be installed adjacent to each other. Because the cable 105 is inserted in an alternating fashion between the first duct 111 and the second duct 113 of successive blocks 20, a staggered edge forms along the paving unit 115. As a first paving unit 115 and a second paving unit 115 are installed adjacent to each other, the paver blocks 20 along the side of the second paving unit 115 are positioned such that they interweave with the blocks 20 along the side of the first paving unit 115 in a “zippered” fashion, creating a continuous paved surface. In addition, the outer row of the ducts 110 along each edge of the paving units 115 may be left open during initial assembly because a cable 105 inserted in this row would alternately pass through a duct 110 and open space. However, once adjacent paving units 115 have been installed, the outer row of ducts 110 of one paving unit 115 align with the outer row of ducts 110 of the other paving unit 115. Optionally, an interlocking cable 120 may, therefore, be passed through the two paving units, securing the first paving unit 115 to the second paving unit 115.

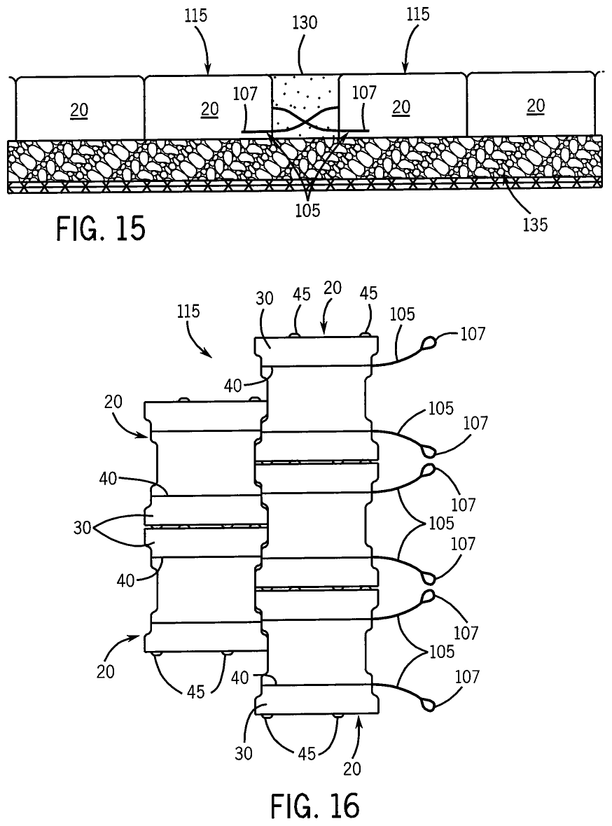

Multiple paving units 115 may also be installed in an end-to-end configuration. According to one embodiment of the invention, illustrated in FIGS. 14 and 15, the lifting loops 107 of the first paving unit 115 are tucked into the cavities 40 of the paver blocks 20 at the end of the second paving unit 115. Likewise, the lifting loops 107 of the second paving unit 115 are tucked into the cavities 40 of the paver blocks 20 at the end of the first paving unit 115. A sheath is laid into the gap between the two paving units 115. Preferably, a very narrow veneer plastic sheath is used. Moreover, the preferred plastic sheath is only ten to twelve inches wide and eight to ten mils thick. This sheath prevents grout from entering the cavities 40 of the paver blocks 20 at the end of either paving unit 115 and additionally isolates the cables 105 from the grout. Finally, grout is poured between the two paving units 115 to form a joint 130. The grout may be of any type known to one of skill in the art and suitable for the application, but is preferably a pervious concrete or small aggregate grout.

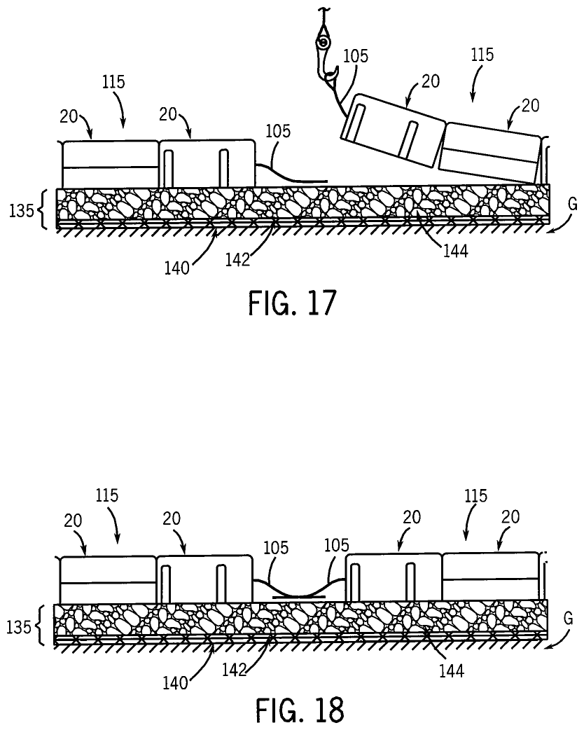

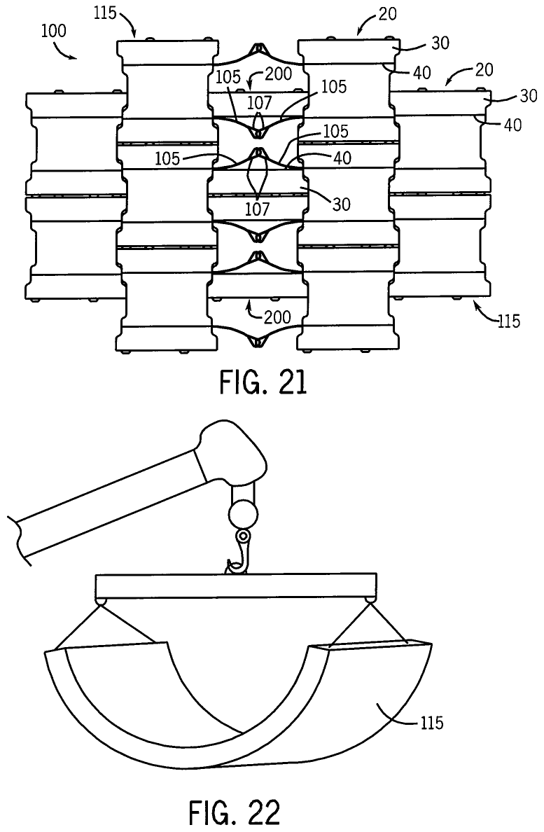

According to another embodiment of the invention, illustrated in FIGS. 17-21, a second installation method is illustrated. A first paving unit 115 and a second paving unit 115 are installed in an end-to-end configuration. Due to the symmetry of the paving units 115, a first end 117 of one paving unit 115 may be placed adjacent to either a first end 117 or a second end 119 of another paving unit 115. The paving units 115 are spaced apart by a width substantially equal to the depth, D1, of one paver block 20. The lifting loops 107 of adjacent paving units 115 are positioned on the subgrade 135 such that they align with a storage cavity 40 in a subsequently inserted lock block 200. Lock blocks 200 are inserted between the two paving units 115 to form a generally continuous surface between the two paving units 115. According to one embodiment of the invention, each of the lock blocks 200 is substantially the same as each of the paver blocks 20 used in the paving units 115. Optionally, the lock blocks 200 may be of any suitable form to cover the lifting loops 107 and span the distance between the two paving units 115.

Prior to installing the paving units 115, a suitable subgrade 135 may be laid over the ground, G, on which the paving system 100 is to be installed. The thickness and/or composition of the subgrade 135 may vary according to the site requirements. According to one embodiment of the invention, a barrier layer 140, such as a geogrid or geotextile material, may first cover the ground, G. A first layer of stone 142 covers the barrier layer 140. The first layer of stone 142 may be between 5 and 10 inches (12.7 and 25.4 cm) thick and includes stone having a diameter of about 1 to 1 and one-half inches (2.5 to 3.8 cm). A second layer of stone 144 covers the first layer of stone 142. The second layer of stone 144 is preferably one half inch (1.3 cm) thick and more preferably at least one inch (2.5 cm) thick, including stone having a diameter less than 1 inch (2.5 cm).

Each paving unit 115 is preferably installed as a single unit. Referring to FIG. 22, an exemplary paving unit 115 is being lifted using a crane, but installation may be performed by any means known to one skilled in the art, such as a forklift. Further, if cleaning of the cavities 40 of the paver blocks 20 becomes necessary, the paving unit 115 may be subsequently lifted out, the cavities 40 and subgrade 135 cleaned of debris, and the paving unit 115 reinstalled.

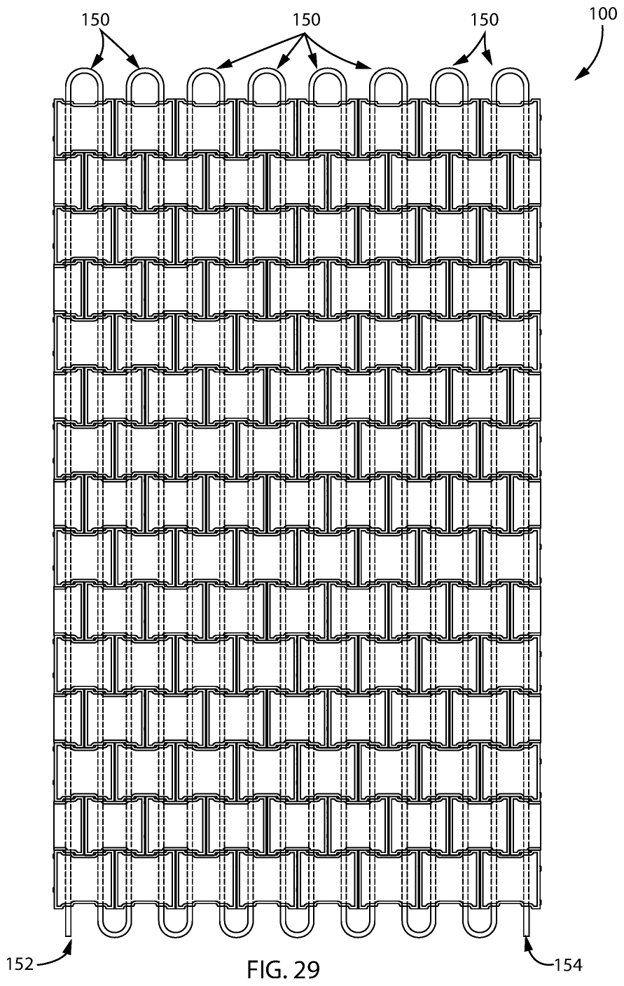

According to another embodiment of the invention, illustrated in FIG. 29, yet another embodiment of the invention is illustrated. In some installations, installation of individual paver blocks 20 may be preferred. As a result, the ducts 110 of the paver system 100 may be free of cables 105. Consequently, tubing 150 may be installed through the ducts 110 of the paver system 100. The tubing may be of any suitable material, including but not limited to, plastics such as poly-vinyl chloride (PVC), cross-linked polyethylene (PEX), or high density polyethylene (HDPE) or metals such as copper or stainless steel. According to the illustrated embodiment, the tubing 150 may be installed as a continuous fluid path through the entire paving system 100. The fluid within the tubing 150 may enter the ducts at 152 and exit at outlet 154, or vise versa. Optionally, the tubing 150 may be configured to define multiple fluid paths over different portions of the paving system 100. The tubing 150 may circulate a liquid in order to provide hydronic heating to the paving system 100. While any method of hydronic heating may be used, the preferable form is a water loop. In one embodiment, glycol may be used as the fluid.

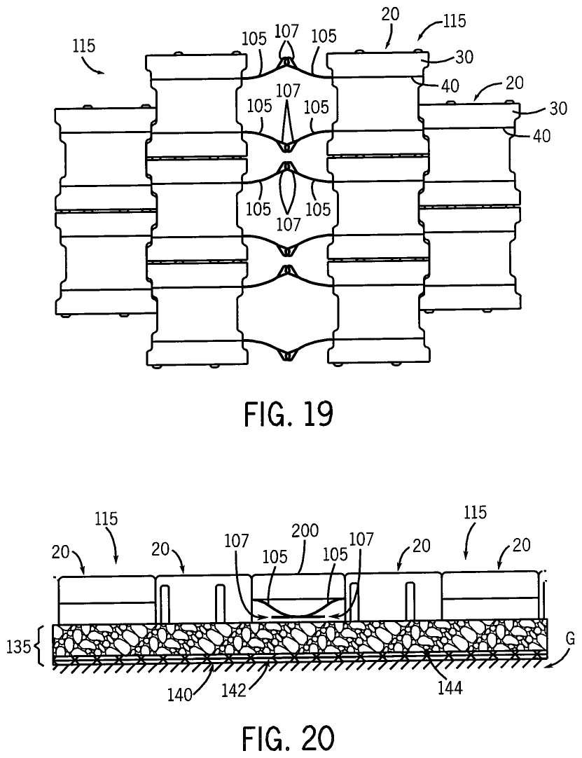

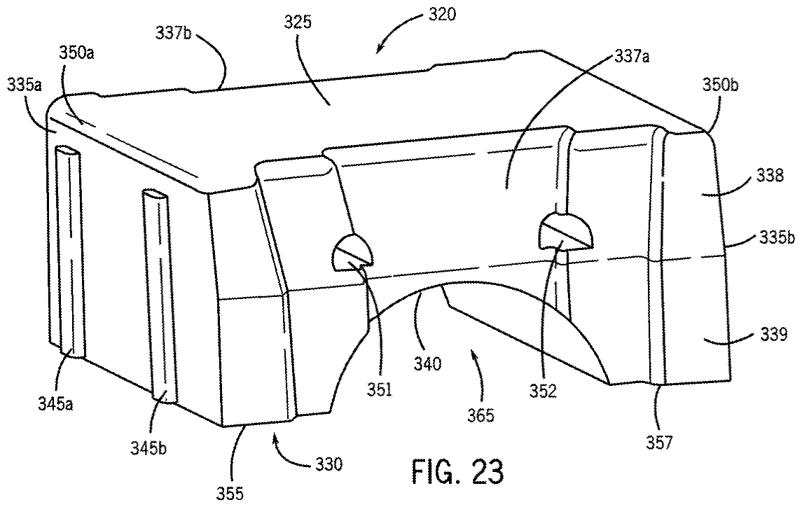

Also referring to FIG. 29, an alternate embodiment is disclosed. In this embodiment, an electric wire may replace tubing 150. The wiring may be wrapped in a sheath and passed through the ducts 110 as shown for example in FIG. 26 and ducts 351 and 352 in FIG. 23. In yet another embodiment, the cable 105, as shown in FIG. 19 may replace the tubing 150 and also insulated with a sheath. The insulated cable may then be used for electric heating, by passing an electric current through the cable, using it as an electrical resistor heater. In such a configuration the cable 105 is not necessarily required to pass through every duct 110, 351, 352, but may pass through every other duct 110, 351, 352, to conserve energy. Solar panels and battery packs, as opposed to direct electrical grid connection, may also be used to further conserve energy and provide a sustainable power source for the heating system.

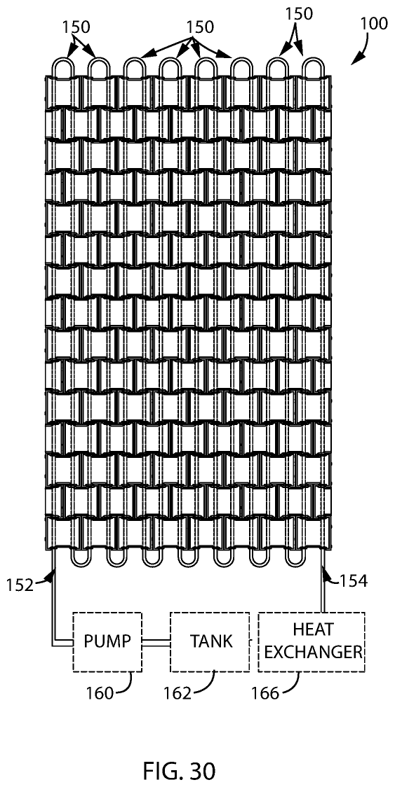

Referring to FIG. 30, a self-regulating heated collection of connected blocks 20, or a mattress 250 is shown. In this configuration, a thermostat 252 may be used to control the operation of a pump 160 in order to regulate the temperature of the mattress 250 in a predetermined range. The thermostat 252 may be hard-wired to the pump 160 or in wireless communication. The pump 160 passes fluid through an inlet 152 to circulate fluid contained within the tubing 150. The outlet 154 may return to the pump 160 or, optionally, return to a tank 162 storing the fluid. A supply line from the storage tank 162 to the pump 160 may complete the fluid path. A heat exchanger 166 may also be included in the paving system 100 to either increase or decrease the temperature of the fluid conducted in the fluid path. As fluid flows through the tubing 150, the temperature of the paver blocks 20 may similarly be increased or decreased according to the temperature of the fluid conducted therethrough. Optionally, the heat exchanger 166 and the pump 160 may be combined into a single unit.

Continuing with FIG. 30, electrical wiring or a cable 105, as shown in FIG. 19, may replace the tubing 150. The wiring, or tubing 150 may further be preassembled in the mattress 250 so that the mattress may be delivered to the job site with the tubing 150 or wiring already present within the ducts 110, 351, 352. This configuration saves setup time and labor at the job site. As mentioned above, the thermostat 252 may be configured to control the electrical current passed through the cable, such that the mattress 250 is self-regulating with respect to temperature. Either configuration, liquid heating or electric heating, may totally eliminate the need for snow removal, salting, sanding, or any other commonly done maintenance in cold climates. The heated mattress prevents snow or ice from accumulating. A temperature of approximately 35 to 39 degrees Fahrenheit is needed to prevent a mattress 250 from such accumulation. At this temperature, energy may be conserved as the thermostat 252 prevents excessive heating of the mattress 250. In the event of ground movement, or heavy machinery moving the mattress 250, it may become possible that the electric wire within the ducts 110, 351, 352 break. In such an event, the individual blocks 20 in the area of the break may be removed from the mattress 250 and new wire may be spliced in to perform a repair. Lastly, pump 160, storage tank 162, and heat exchanger 166 may all be replaced with a battery pack and/or a solar power system.

In operation, the paving units 115 are installed according to the requirements of each paving system 100. The ground, G, of the installation site is tested to determine the appropriate composition and thickness of the subgrade 135. After laying the subgrade 135, the paving units 115 are installed to cover the installation site. Individual blocks 20 are inserted around the perimeter of the paving system 100 as necessary to provide a generally linear edge. Lock blocks 200 are inserted between paving units 115 to complete the surface of the paving system 100. When rain falls on the paving system 100, the rain runs down between the blocks 20 and is either filtered into the subgrade 135 or stored in the cavities 40 of the paving system 100 according to the capacity of the subgrade 135 and the rate of rainfall. As the rate of rainfall slows and/or stops, additional water stored in the cavities 40 of the blocks 20 is filtered into the subgrade 135. The cavities in each of the plurality of blocks has sufficient volume to store at least one inch (2.5 cm) of rain from the upper surface of the plurality of blocks in the paving unit.

The paving unit 115, after having been installed, may require occasional cleaning. The paving system 100 is configured such that each of the lock blocks 200 along one end of a paving unit 115 may be removed, allowing the paving unit 115 to be subsequently lifted as a single unit and to allow cleaning of the cavities 40 of the blocks 20, as necessary. Any debris or particulate present on the surface of the subgrade 135 may similarly be removed. Once the cleaning is complete, the steps may be reversed. The paving unit 115 is reinstalled and each of the lock blocks 200 reinserted. Optionally, access to the cavities 40 may be provided from one end of the paving system 100 and the blocks 20 may be cleaned while the paving units 115 remain installed.

Turning now to FIG. 23, another embodiment of the inventive block is shown. Block 320 may also be used in a permeable pavement or permeable paving system 100 (not shown). The block 320 has an upper surface 325, a lower surface 330, a first side wall, or side, 335a, a second side wall, or side, 335b, a first end 337a, a second end 337b, and a cavity 340. As illustrated, the paver block 320 has two generally flat sides, 335a and 335b, and two ends, 337a and 337b, that have a stepped structure. In this embodiment, the stepped sides protrude more than the embodiment described above. This helps the block have a more tightly fitting interconnection with similarly-shaped adjacent blocks. A pair of drainage spacers 345a, 345b preferably extend almost all of the height along both of the sides 335a and 335b of the paver block 320 from surface 325 to surface 330. All of edges, e.g., 350a and 350b between the upper surface 325 and each of the sides, 335a and 335b, and each of the ends, 337a and 337b, will be rounded, creating seepage down the block. Further, upper portion 338 of end 337a is angled slightly inwardly relative to lower portion 329 of side 337a. End 337b may be similarly constructed. At least two ducts 351, 352 are provided for receiving attachment cables. Finally, the lower surface 330 preferably has two feet 355 and 357 which come into contact with the aggregate on the ground. The feet 355 and 357 are separated by the cavity 340 which forms water drainage channel 365.

In one preferred embodiment, a mix used to construct a paving unit made up of about 125 blocks includes about:

700 LBS CEMENT

2875 LBS LIMESTONE

2475 LBS C. SAND

11 OZ PLP (PLASTICIZER—Acme)

16 OZ BF3 (DENSIFIER/PLASICIZER—Essroc)

It should be noted that the invention can be utilized with existing permeable and non-permeable paving systems. For example, it is possible to install a subgrade 135 in or next to an existing concrete or asphalt parking lot. A paving unit 115, sized appropriately, may then be placed on the subgrade 135. Alternately, the subgrade 135 and paving unit 115 may be laid down first. Appropriate spacers and/or screens are placed along each end of the paving unit 115 to prevent concrete or asphalt, being laid adjacent to the paving unit 115, from entering the cavities 40, fluid passages 65, or ducts 110 of the paving unit 115 as the concrete or asphalt is poured into the surrounding area.

In addition, referring to FIGS. 24-26, one embodiment may include a depth D1 of 12 inches and a width W1 of 12 inches. The distance between a center point of spacers 45 may be at 6.75 inches with one of the spacers 45 a distance of 1.375 inches from the center point of the respective spacer 45 to a corner of the block 20. The spacers may have a width W4 of 1 inch and a depth D4 of 0.25 inches. The spacers may also include a curvature about the width W4 of a radius at 0.25 inches. Ducts 110 may be spaced apart from the center point of each duct 110 by a space of 6.125 inches and each have a diameter of 1 inch. The ducts 110 are also preferably spaced from the edge of the channel 365 by a space of 1.319 inches. The channel 365, while not shown in FIG. 24 is similar to that shown in FIG. 23, and may include a radius of 3.344 inches with a diameter of 6.502 inches. The upper surface 35 of the block 20 may also include a curvature of 0.5 inches between the upper surface 25 and side, 35b, first end 37a, and second end 37b. While FIGS. 27 and 28 show the spacers 45 at a height of H4, preferably the spacers 45 extend from the flower surface 30 to the upper surface 25. Also, the alpha angle shown in FIG. 27 preferably includes an angle of 30 degrees.

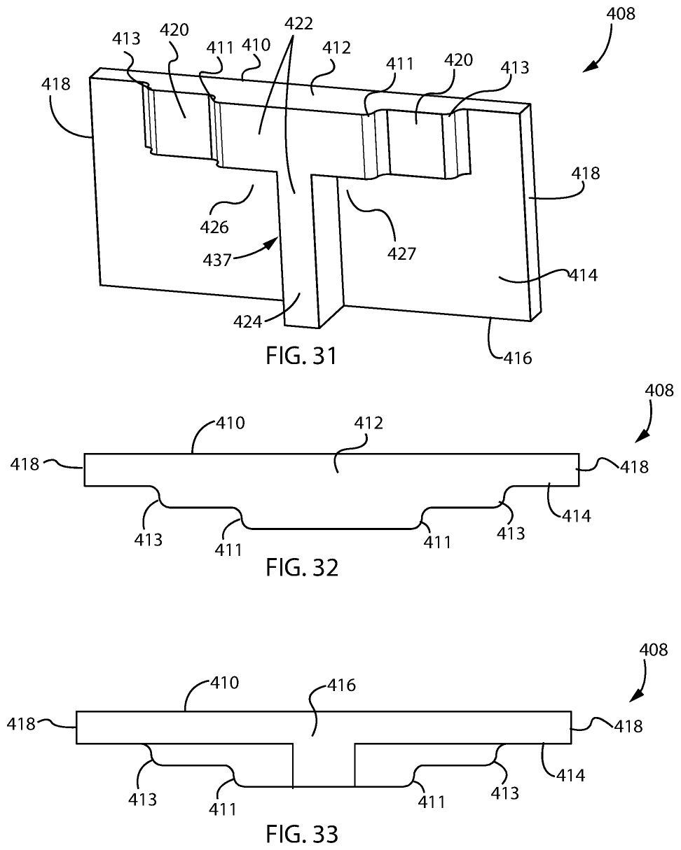

Referring to FIGS. 31, 32, and 33, an end cap 408 is shown. The end cap 408 may be constructed out of a multitude of materials including rubber, plastic, foam, or any other compressible material. Preferably, the end cap 408 is formed out of a recycled rubber. A particularly good source of recycled rubber may be automotive tires which have been ground into small particles. The particles of automotive tire may then be bonded together with an adhesive to form the end cap 408 in a mold. The resulting end cap 408 is therefore compressible, pliable, and slightly deformable. The end cap 408 may also be water permeable. These properties allow the end cap 408 to be an effective expansion joint for a paving block system. The end cap 408 may absorb expansion of the paving block or an abutting surface such as asphalt, concrete, stone, dirt, a structure, or any other object during climate changes.

The end cap 408 includes a top 412 that is generally parallel to the bottom 416. The generally parallel sides 418 connect the top 412 to the bottom 416, and are each generally perpendicular to the top 412 and bottom 416. The end cap 408 may also include rounded edges or be formed into a multitude of shapes such as rectangular, square, trapezoidal, or any other shape. On the front 414 of the end cap 408, a first raised edge 420 extends along a portion of the top 412. A second raised edge reforms 422 on top of the first raised edge 420 along the top 412 and includes a projection 424 that extends generally perpendicular from the top 412 and the first raised edge 420 toward the bottom 416 of the end cap 408. A first recess 426 is formed on one side of the projection 424, and a second recess 427 is formed on the opposing side of the projection 424. The first raised edge 420, second raised edge 422, and the projection 424 form a generally “T”-shape 437, stepped formation on the front 414 of the end cap 408. The first raised edge 420 transitions to the front 414 with a rounded outside edge. The second raised edge 422 transitions from the first raised edge 420 with a rounded inside edge. Rounded edges allow the end cap 408 to be removed from a mold during the manufacturing process with minimal effort. The front 414 of the end cap 408 is preferably positioned against at least one paving block while the back 410 of the end cap 408 rests against an abutting surface.

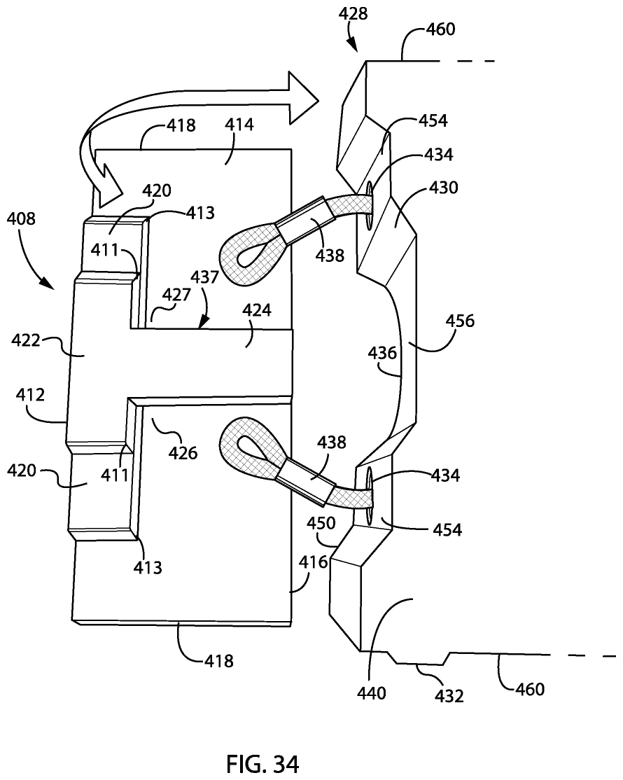

Turning now to FIG. 34, the end cap 408 is shown next to an exemplary paving block 428. A paving block 428 of this type includes a generally planar top 440 parallel to a generally planar bottom 450. The front 430 of the paving block 428 is non-planar and may include a series of steps. The general shape of the front 414 of the end cap 408 includes a first raised edge 420, second raised edge 422, and projection 424 that may fit against the front 430 of the paving block 428. Rounded outside edges 413 transition the first raised edge 420 from the front of the end cap 408 and rounded inside edges 411 transition the second raised edge 422 from the first raised edge 420. The first and second raised edges 420, 422, along with the projection 424, form a general “T”-shaped formation.

When the end cap 408 is fitted against the paving block 428, the first raised edge 420 of the end cap 408 fits against a first step 454 on the front 430 of the paving block 428, while the second raised edge 422 of the end cap 408 fits against a second step 456 in the front 440 of the paving block 428. The projection 424 of the end cap 408 also fits against the second step 456 of the paving block 428. This produces a snug fit and allows the front 414 of the end cap 408 to effectively match the contour of the front 430 or back 458 of the paving block 428.

The paving block 428 preferably includes a cavity 436 extending along the bottom 450 of the paving block 425 to assist in the flow of water under the paving block 428. The cavity 436 is particularly useful when the paving block is placed on an inclined surface, such as a hill, and allows water to easily flow downhill under the paving block 428. At least one spacer 432 may be included on the sides 460 of the paving block 428 to ensure a gap is always present between each paving block 428 to allow water to seep to the ground.

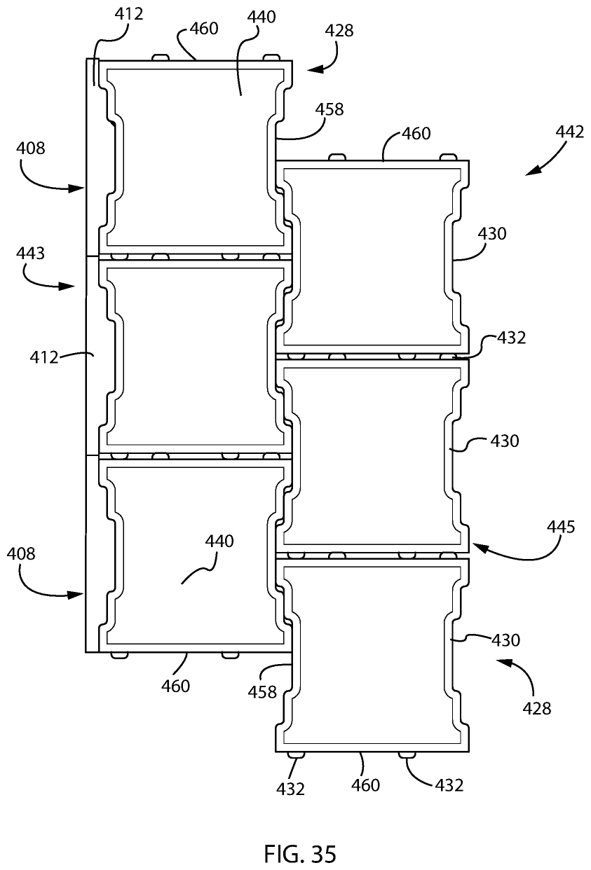

A channel 434 may also be included along the front 430 of the paving block 428 extending through the core of the paving block 428 and generally parallel to the top 440 and bottom 450. Preferably, the paving block 428 includes two channels 434 on the first step 454 of the paving block 428 with the second step 456 in between each channel 434. The channels 434 extend through the paving block 428 and produce passages for a cable 438 to pass through the paving block 428. The cable 438 may therefore protrude from each channel 434. The front 414 of the end cap 408 may be placed against the front 430 of the paving block 428 allowing the cables 438 to fit snugly within the first recesses 426 and the second recess 427 on the end cap 408. This configuration allows for the cables to be obscured from view when the paving block 428 is installed as shown in FIGS. 34 and 35.

Additionally, the cables 438 coming out of each channel 434 may not be individual cables that are crimped as shown in FIG. 34. Alternatively, a cable 438 may come out of one channel 434 and enter the other channel 434 in the paving block 428, thus forming a loop. Such an arrangement would create one single cable 438 exiting on channel 434 and entering another channel 434. In this example, when fitting an end cap 438 against the front 430 of the paving block 428, the loop of the cable 438 may be tucked under the paving block 428 into the cavity 436. Tucking the cable 438 into the cavity 436 underneath the paving block 428 would also allow the front 414 of the end cap 408 to sit flush against the front 430 of the paving block 428 as shown in FIG. 35.

In another embodiment the cable 438 passing through channels 434 may be replaced with a heating system. The heating system may include hollow tubing for heated water to circulate through the paving block 428. Preferably, an electric wire may be wrapped in a sheath and passed through the channels. In yet another embodiment, the same cable 438 maybe insulated with a sheath and used for electric heating by using the cable 438 as an electrical resistor heater. In such a configuration the cable 438 is not necessarily required to pass through every channel 434, but may pass through every other channel 434, to conserve energy. Solar panels and battery packs may also be used to further conserve energy and provide a sustainable power source for the heating system.

Turning now to FIG. 35, multiple paving blocks 445 and end caps 408 are shown. A plurality of paving blocks 445 may be preassembled by running the cable 438 shown in FIG. 33 through the channels 434 in each paving block 428. This system of assembling multiple paving blocks 445 together is described in U.S. Patent Publication 2012/0141202, the entirety of which is expressly incorporated by reference, and particularly in FIG. 16 of that publication. The spacers 432 ensure a gap is always present between each paving block 428. The multiple paving blocks 445 that are interconnected with the cable 438 form a paving system 442. The entire paving system 442 may be laid into place by lifting it and lowering it with the attached cable 438. Once the paving system 442 is in place, the end cap 408 may be positioned into place to form an expansion joint and also to conceal the cable 438 as described above and shown in FIG. 33. While the paving block 428 may be formed of a water permeable concrete mixture, the spacers 432 ensure that a sufficient amount of water may permeate through the paving system 442 to the ground below. Preferably, the end cap is sized such that one end cap fits against a single paving block 428. The end caps 408 may, however, be longer to allow a single end cap to fit against a plurality of paving blocks 428. The end cap also functions as an expansion joint 443 as the multiple paving blocks 445 expand and contract during climate changes. FIG. 35 also shows the multiple paving blocks 445 forming a non planar edge 49 along the end caps 408. Due to the profile shape of the end caps 408 matching the profile of the paving blocks 428, the end caps 408 form a planar edge 447 that makes it easier to pour an abutting surface, such as asphalt or concrete.

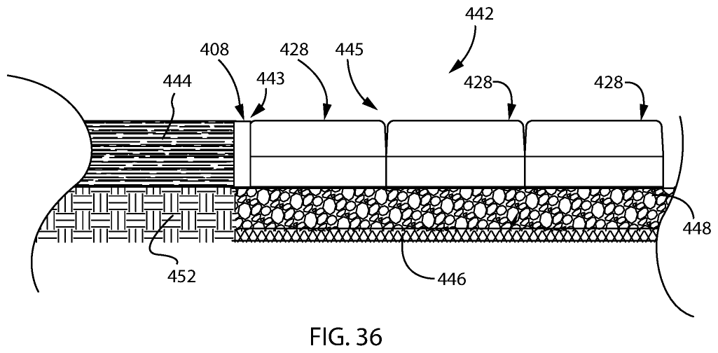

FIG. 36 shows a side view of an installed paving system 442 with a cross-sectional side view of the ground. In order to ensure that each paving block 428 stays in place and that they are even with one another, the undisturbed ground 452 is excavated for a proper foundation to be set in place. The foundation consists of a geogrid 446 or a geotextile 446. A geogrid is a geosynthetic material used to reinforce soils and similar materials. Geogrids 446 are commonly used to reinforce retaining walls, as well as subbases or subsoils below roads, structures, or paving systems 442. Soils pull apart under tension. Compared to soil, geogrids 446 are strong in tension. This fact allows them to transfer forces to a larger area of soil than would otherwise be the case. Geogrids 446 are commonly made with polymer materials such as polyester, polyethylene, or polyproylene. They may be woven or knitted from yarns, heat-welded from strips of material or produced by punching a regular pattern of holes in sheets of material, then stretched into a grid. Geotextiles 446 are permeable fabrics which, when used in association with soil, have the ability to separate, filter, reinforce, protect, or drain. Typically made from polypropylene or polyester, geotextile 446 fabrics come in three basic forms: woven like burlap, needle punched like felt, or heat-bonded like ironed felt. On top of the geogrid/geotextile 446, a stone bedding 448 may be placed. The stone bedding 448 may be approximately 6 to 10 inches deep and consist of a 1 to 1.5 inch diameter clean or recycled stone. Each paving block 428 may then be manually laid on top of the stone bedding 428 or the paving system 442 may be set into place. The end cap 408 acts as an expansion joint 443 between the paving blocks 445 and an abutting surface 444. The abutting surface 444 may include asphalt, concrete, wood, dirt, stone, or any structures such as a house. As climate changes and over time, the paving blocks 445, as well as the abutting surface 444, may expand and contract. The end cap 408 functions as an expansion joint 443 and absorbs the expansion and contraction, conceals the cable 438 as shown in FIG. 33, and is an attractive transition from the paving blocks 28 to the abutting surface 444.

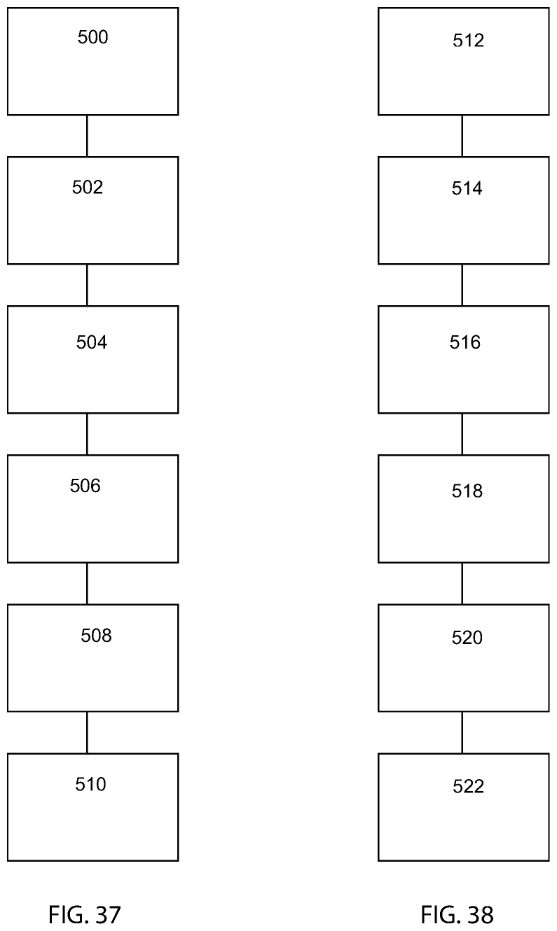

Turning now to FIG. 37, the steps of manufacturing a paving block system are described. First, the paving block is casted 500, preferably, wet casted using a press. Due to the design of the paving block 428, the casting may be completed with a single pressing of the press. The casting includes forming spacers 502 on the sides 460 of the paving block 428, as seen in FIG. 35. The casting also includes forming channels 504 which are shown as channels 534 in FIG. 34. Similarly, the casting includes forming steps 506 which are seen as the first step 454 and second step 456 in FIG. 35. As described with reference to FIG. 35, a cavity 436 allows water to flow under the paving block 428. Forming a cavity 508 is also included in the casting operation. Lastly, molding an end cap 510 produces the end cap 408 as shown in FIGS. 31-35.

FIG. 38 discloses the steps of assembling a paving block system as seen in FIGS. 35 and 36. While excavation is commonly done, it is not mandatory. The first step typically includes laying support 512 in the form of a geogrid and/or geotextile. Laying stone bedding 514 follows to add a strong support for the paving blocks 428 and any load on top of the paving blocks 428. Laying paving blocks 516 follows, and may be done manually with individual paving blocks 428 or as a complete paving block system 442. Inserting an end cap 518 provides an effective expansion joint 443, concealing cable 520, if a paving block system 442 with cables 438 was used. Lastly, preventing debris 522 with the end cap 408 allows water to flow through the cavity 436 and channel 434 of the paving block 428.

Turning now to FIGS. 39-43, an alternative embodiment of the invention is disclosed. In this embodiment, the paving blocks 428 are the same as discussed above with respect to FIGS. 34-36, but the end cap 408 is replaced with an alternative end cap that is referred to as an end block 478. The end cap 408 and end block 478 may be used interchangeable, and as a result, the term “end cap” and “end block” may also be used interchangeably. The end block 478 performs all the same functions as the end cap 408, but has a different shape and is made of a different material, as discussed below.

The end block 478 may be manufactured with the same manufacturing equipment as the paving blocks 428. As shown in FIG. 39, the top view of the end block 478 has the same profile as half of a paving block 428 shown in FIG. 35. The end block 478 does not include cavity 436 or channel 434, however the same equipment may be used to cast the end block 478 by simply removing inserts and adjusting the mold. This allows for manufacturing of the end block 478 in the same location as the paving block 428, thus reducing transportation costs and lead time.

As the end cap 408 is constructed out of a flexible material such as recycled rubber it often requires an adhesive to keep it in place, against the paving block 428, as shown in FIG. 35. The end cap 408 may also be nailed to the paving block for added security. The end block 479 eliminates the requirement of nailing or using an adhesive to keep it in place as the end block 479 is casted out of concrete and stays in place due to its large mass.

Referring specifically to FIGS. 39-42, the end block 479 includes sides 470, a front 484, and a back 480. On the front 484, a first step 474 and a second step 476 form a stepped profile that matches the front 430 of the paving blocks 428. The matching steps on the paving blocks 428 and the end block 478 allow for the paving block system 442 to be formed with straight edges around the perimeter, as shown in FIG. 43. Furthermore, the end block 478 may be cut in half to provide a square edge at the corners of the paving block system 442.

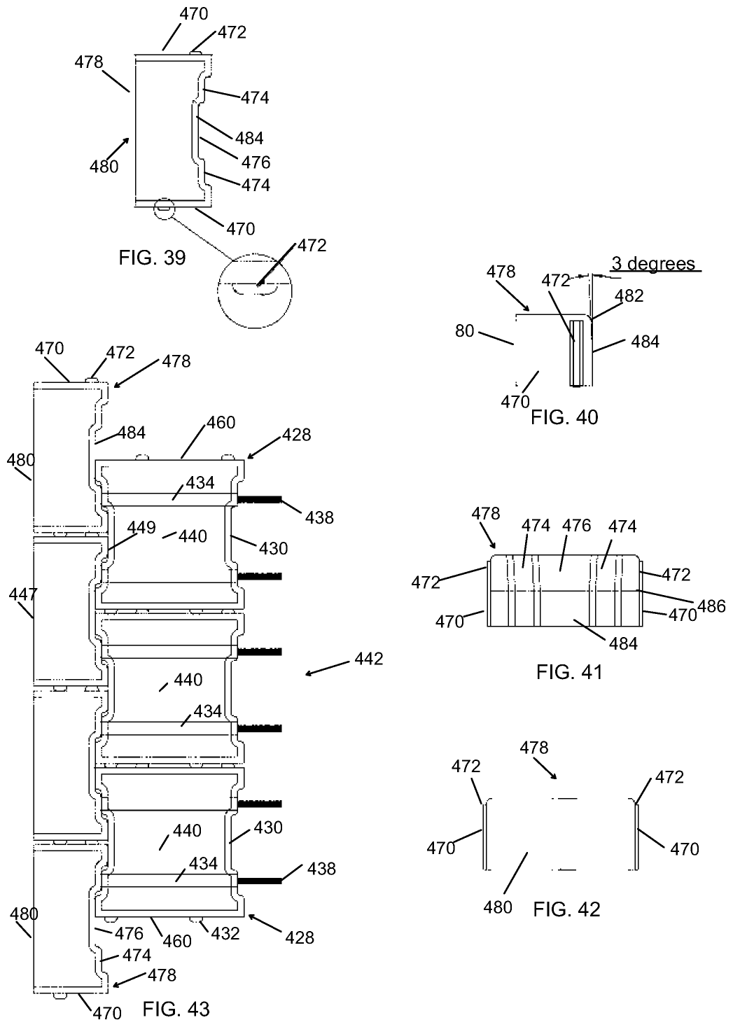

As shown in FIGS. 40 and 41, the end block 478 includes a tapered front. While the taper 482 may be formed out of any degree of slope, preferably, the taper 482 is approximately 3 degrees of slope. The taper 482 may continue along the entire front 484 of the end block 478 but, preferably, ends at the midway point 486 of the front 484 of the end block 478 as shown in FIG. 41. The taper 482 forms a path for water to flow through when the end blocks 478 are assembled in a paving block system 442 as shown in FIG. 43. The end blocks 478 also include a spacer 472 on the sides 470 to allow a drainage space to be formed when assembling the end blocks with a paving block system 442 as also shown in FIG. 43.

The end block 478 performs a similar function as the end cap 408 shown in FIGS. 31-36, but is made out of the same material as the paving block 428 which provides a more uniform appearance while also reducing manufacturing costs. The end block 478 is also installed in a similar fashion as discussed with respect to FIG. 36. The cable 438 may also be tucked into the cavity 436 of the paving block 428 as shown in FIG. 34 when the end block 478 is abutted against the paving blocks 428. The end block 748 may also include a notch to help the cable 438 tuck into the cavity 436 of the paving block 428. Furthermore, the end block 478 may be used in any manner described herein referring to the end cap 408, thus providing for interchangeability between the end cap 408 and the end block 478.

FIG. 43 shows the end block 478 forming a straight edge along the back 480 of the end blocks 478. The straight edge may provide a uniformly-shaped surface along the sides of the paving block system 442 which allows for asphalt or concrete to be laid with less labor than if the first step 454 and the second step 456 of the paving blocks 428 were left exposed. The end blocks 478 also conceal the cable 438 as well as the channels 434, which are shown in phantom view, within the paving blocks 428. Similar to the description above with respect to FIG. 35, FIG. 43 also shows the paving blocks 428 forming a non planar edge 449 along the end caps 408. Due to the profile shape of the end blocks 478 matching the profile of the paving blocks 428, the end blocks 478 form a planar edge 447 that makes it easier to pour an abutting surface, such as asphalt or concrete.

It has been noted that the construction of the block and cavity minimize the puddling of water on the block. Further, ice melts faster off of the inventive block than it does off a conventional surface, again, because of the construction and makeup of the inventive block. Finally, paving projects can be completed much more rapidly and consistently than poured concrete projects or those accomplished with asphalt because of the construction of the block and the paving unit.

Although the best mode contemplated by the inventors of carrying out the present invention is disclosed above, practice of the present invention is not limited thereto. It will be manifest that various additions, modifications, and rearrangements of the features of the present invention may be made without deviating from the spirit and scope of the underlying inventive concept.

For example, individual components of the disclosed block and paving unit need not be formed in the disclosed shapes, or assembled in the disclosed configuration, but could be provided in virtually any shape, so as to provide a paver block/unit with the novel features, e.g., a cavity capable of storing fluid. Furthermore, all the disclosed features of each disclosed embodiment can be combined with, or substituted for, the disclosed features of every other disclosed embodiment except where such features are mutually exclusive.

It is intended that the appended claims cover all such additions, modifications, and rearrangements. Expedient embodiments of the present invention are differentiated by the appended claims.

What is claimed is:

1. A method of forming a permeable paving system comprising:
installing a plurality of preformed paving blocks to form a paving surface, wherein each of the preformed paving blocks includes:
an upper surface;
a lower surface generally parallel to and spaced apart from the upper surface; and
a pair of parallel ducts extending horizontally through the block between the upper surface and the lower surface;
inserting a transmission device through at least one of the parallel ducts of each paving block of the plurality of preformed paving blocks;
using a controlling device to control the transmission device such that the temperature of the plurality of preformed paving blocks is automatically maintained at a predetermined range, wherein the controlling device selectively adjusts one of electrical current through the transmission device or circulation of a fluid through the transmission device.

2. The method of claim 1 further comprising connecting a pump to the transmission device, the pump configured to circulate the fluid through the transmission device;
wherein inserting the transmission device through at least one of the parallel ducts of each paving block of the plurality of preformed paving blocks comprises inserting at least one tube through aligned parallel ducts of each paving block; and
wherein each tube is connected to the pump to circulate fluid.

3. The method of claim 2 further comprising connecting a heat exchanger to the transmission device, the heat exchanger configured to exchange thermal energy with the fluid.

4. The method of claim 2 wherein the fluid is glycol with a temperature of about 39 degrees Fahrenheit.

5. The method of claim 2 wherein the controlling device is a thermostat programmed to control the temperature of the fluid flowing through the tube.

6. The method of claim 2 further comprising connecting a storage device capable of storing a solar energy and transmitting the solar energy to the pump and the controlling device, wherein the controlling device is a thermostat programmed to deliver the stored solar energy to the fluid flowing through the transmission device and to maintain the predetermined temperature range of the plurality of preformed paving blocks within 35 to 39 degrees Fahrenheit.

7. The method of claim 1 wherein inserting the transmission device through at least one of the parallel ducts of each paving block of the plurality of preformed paving blocks comprises inserting an electrically conductive wire through aligned parallel ducts of each paving block; and
wherein the electrically conductive wire is encapsulated within a non-electrically conducting sheath.

8. The method of claim 7 wherein the controlling device is a thermostat programmed to control the amperage of the electrical current flowing through the transmission device to maintain the predetermined temperature range of the plurality of preformed paving blocks within 35 to 39 degrees Fahrenheit.

9. The method of claim 8 further comprising connecting a storage device capable of storing a solar energy and transmitting the solar energy to the controlling device.

10. A method of forming a permeable paving system, comprising:
installing a plurality of preformed blocks, wherein each of the paving blocks includes:
an upper surface;
a lower surface generally parallel to and spaced apart from the upper surface;
a first side;
a second side opposite the first side; and
a pair of ducts extending through the preformed block between the first side and the second side;
inserting a transmission device through at least one duct in each of the plurality of performed blocks to form a circuit for circulation of a fluid through each of the plurality of preformed blocks;
connecting a pump to the transmission device to circulate the fluid through the transmission device; and
connecting a controlling device to the pump to selectively adjust circulation of the fluid through the transmission device such that a temperature of the plurality of preformed blocks is automatically maintained at a predetermined range.

11. The method of claim 10 wherein the controlling device is a thermostat that prevents excessive heating of the plurality of preformed blocks.

12. The method of claim 10 further comprising disposing a barrier layer below the plurality of preformed blocks;
wherein the at least one tube supports the weight of the plurality of preformed blocks and joins each one of the plurality of preformed blocks together to form a block mattress.

13. The method of claim 10 further comprising:
connecting a storage device capable of storing a solar energy; and
transmitting the solar energy to the pump and the controlling device, the controlling device being a thermostat programmed to deliver the stored solar energy to the fluid flowing through the transmission device.

14. The method of claim 10 wherein the fluid is glycol.

15. A method of forming a permeable paving system comprising:
installing a plurality of preformed blocks, wherein each of the preformed blocks includes:
an upper surface;
a lower surface generally parallel to and spaced apart from the upper surface;
a first side;
a second side opposite the first side; and
a pair of ducts extending through the preformed block between the first side and the second side;
extending a transmission device through at least one duct in each one of the preformed paving blocks to form a circuit through each one of the preformed paving blocks, wherein the transmission device comprises an electrically conductive wire encapsulated within a non-electrically conducting sheath; and
connecting a controlling device to the transmission device to selectively adjust the amperage of the electrical current flowing through the transmission device such that a temperature of the preformed paving blocks is automatically maintained at a predetermined range.

16. The method of claim 15 wherein the controlling device is a thermostat programmed to control the amperage of an electrical current flowing through the electrically conductive wire.

17. The method of claim 15 further comprising connecting an electricity storage device capable of storing solar energy to at least one of the transmission device and the controlling device.

18. The method of claim 15 further comprising disposing a barrier layer between a ground surface and the plurality of preformed paving blocks, the barrier layer comprising a geogrid or geotextile material.

19. The method of claim 15 further comprising:
connecting a storage device capable of storing a solar energy; and
transmitting the solar energy to the controlling device, the controlling device being a thermostat programmed to control the amperage of an electrical current flowing through the electrically conductive wire.

20. The method of claim 15 wherein the electrically conductive wire supports the weight of the plurality of preformed blocks and joins each one of the plurality of preformed blocks together to form a block mattress
